(19) United States
(12) Patent Application Publication
(10) Pub. No.: US 2014/0124635 A1
(43) Pub. Date: May 8, 2014

(54) Price Channel Extrusion With Sign Holding Grip

(71) Applicant: Patrick J. Barkdoll, Pecatonica, IL (US)

(72) Inventor: Patrick J. Barkdoll, Pecatonica, IL (US)

(73) Assignee: Southern Imperial, Inc., Rockford, IL (US)

(21) Appl. No.: 14/152,676

(22) Filed: Jan. 10, 2014

Related U.S. Application Data
(63) Continuation of application No. 11/403,428, filed on Apr. 13, 2006, now abandoned.

(51) Int. Cl. G09F 3/20; B29C 47/00

(52) U.S. Cl. CPC G09F 3/204; B29C 47/0009
USPC 248/205.1; 264/177.1

(57) ABSTRACT

A label holder for a retail display apparatus is provided. The label holder comprises a front panel, a sign clip, and a shelf mount for securing the label holder to the retail display apparatus. The label holder is formed from an extruded plastic material. The sign clip includes a leg portion and resiliently biases to secure a sign between a leg portion of the sign clip and a front surface of the front panel. The sign clip is integrally connected to the front panel via an integral hinge and pivots relative to the front panel through the first integral hinge between a normal state and a biased state. In the normal state, the leg portion of the clip is positioned proximate the front panel. In the biased state, the leg portion is spaced apart from the front panel and holds a secondary sign therebetween.

### CROSS-REFERENCE TO RELATED PATENT APPLICATIONS

This patent application is a continuation of co-pending U.S. patent application Ser. No. 11/403,428, filed Apr. 13, 2006, the entire teachings and disclosure of which are incorporated herein by reference thereto.

### FIELD OF THE INVENTION

This invention generally relates to the field of label holders for merchandise displays, and in particular, to label holders for mounting onto a shelf.

### BACKGROUND OF THE INVENTION

The present invention is related to price channel label holders that can be extruded of plastic with a clear front panel that forms, in combination with a back panel or the front face of a shelf, a cavity for retaining paper labels therebetween. These label holders have removed the need for adhesive backed labels or labels of flexible plastics as well as highly-durable labels because paper labels can be placed within the pocket and are protected by the clear front panel.

These label holders can either snap to a shelf or be attached with an adhesive strip. These label holders have greatly reduced the cost in producing labels because the labels are less susceptible to damage and can be made from lower quality material.

However, on occasion, retail products go on sale or there may be a need to point out a unique or new feature of a product, which requires a new temporary label or a product description sign. This new information may only be displayed for a short period of time making it impractical to place it behind the front panel. Alternatively, the additional information may be displayed on a sign having dimensions that are too large to fit within the main cavity provided by the label holder. Previous label holders have attempted to solve this problem by providing a secondary label clip for holding the additional labels, for example U.S. Pat. Nos. 6,266,906 and 6,708,436 to Nagel. Unfortunately, these label holders require a second softer material for gripping the additional label. This softer material must be co-extruded with the rest of the clip causing the extrusion process to be complex and requiring an additional extrusion screw head.

Thus, there is a need in the art for providing a label holder that functions as a standard label holder as well as more easily and more reliably holds additional labels or signs, while being more easily and efficiently manufactured.

### BRIEF SUMMARY OF THE INVENTION

The invention is directed towards a label holder with an integral secondary sign retainer clip that more reliably secures signs with a plastic extrusion by coiling the extruded extension of the clip inside of itself The label holder includes a front panel formed of a plastic material. The label holder further includes a clip integrally connected along a top portion of the front panel. The clip includes a top portion extending forward of the front panel and a generally U-shaped bottom portion. The generally U-shaped bottom portion having an outer leg portion and an inner leg portion joined at a bottommost boundary of the clip. The inner leg portion extending upwardly and spaced between the outer leg portion and the front panel. The label holder further includes a sign entrance gap formed between the U-shaped bottom portion and the front panel to guide insertion of a sign. The label holder includes a shelf mount structure connected to the front panel adapted to secure the label holder to a shelf.

Another aspect or feature of the present invention is that such a secondary sign retainer clip of a label holder can consist of the same plastic material throughout, such that extrusion and manufacture of the label holder stays relatively simple. The label holder includes a front panel of a plastic material. The front panel has a front surface. The label holder further includes a clip integrally connected to the front panel by a first integral hinge. The clip is pivotable relative to the front panel through the first integral hinge. The clip includes a second integral hinge disposed between the first integral hinge and a leg portion extending upwardly from the second integral hinge. The leg portion includes a gripping surface that faces the front panel. The clip and front panel consist of a single material of a constant hardness characteristic.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view of a label holder installed on a shelf structure having the label holder and the sign clip in a biased state with a main label positioned behind a front panel and a secondary sign secured by the sign clip in accordance with an embodiment of the present invention;

FIG. 2 is another side view of the label holder of FIG. 1 wherein the label holder is free of signs and labels;

FIG. 3 is an enlarged partial illustration of the sign clip of FIG. 2;

FIG. 4 is a perspective view of the label holder of FIG. 1;

FIG. 5 is a side view of a label holder installed on a shelf structure shown in a biased state in accordance with another embodiment of the present invention;

FIG. 6 is a side view of the label holder of FIG. 5 shown with the label holder free of signs and labels;

FIG. 7 is a side view of a label holder installed on a shelf structure shown in a biased state in accordance with another embodiment of the present invention;

FIG. 8 is a side view of the label holder of FIG. 7 shown with the label holder free of signs and labels;

FIG. 9 is a side view of a label holder installed on a shelf structure shown in a biased state in accordance with another embodiment of the present invention; and

FIG. 10 is a side view of the label holder of FIG. 9 shown with the label holder free of signs and labels.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

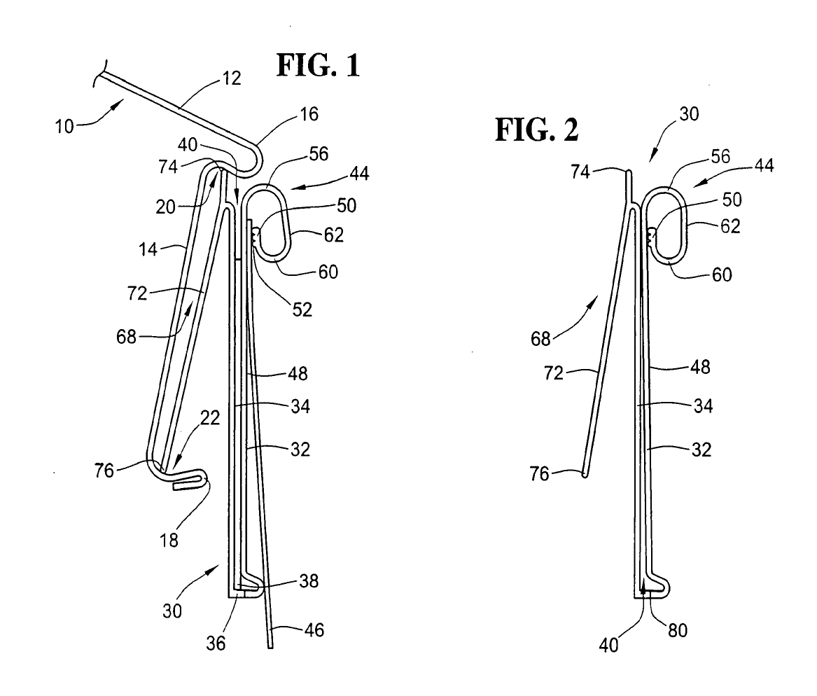

Referring now to the figures, FIG. 1 illustrates a typical “C-channel” shelf structure 10 having a top surface 12, a front panel 14, a top retainer portion 16 and a bottom retainer portion 18. The front panel 14 extends vertically between the top retainer portion 16 and the bottom retainer portion 18 to form a “C-channel” structure to which signs and sign holders can be snapped into and out of Specifically, the top retainer portion 16 and front panel 14 form an upper pocket channel 20 therebetween. Similarly, the bottom retainer portion 18 and the front panel 14 form a lower pocket 22 therebetween. Respective opposing edges of sign or sign holder can be releasably snapped into the pockets 20, 22 to temporarily secure a sign or sign holder. The top shelf surface 12 can be structured to hold products such as would be appropriate for retail display. Furthermore, the top shelf surface 12 may be horizontal or slanted downward depending on the application. Typically, the shelf structure 10 will be formed from a metal, but can be formed of other materials.

Also shown in FIG. 1 is a label holder, generally designated by reference number 30. The label holder 30 is preferably extruded from a plastic material, such as polyvinyl chloride, Butryrate, Provista, or acrylonitrile butadiene styrene (ABS). The label holder 30 includes a front panel 32 and a back panel 34 that are joined at the bottom 36 of the label holder 30 at intersection 80 in FIG. 2. In this embodiment, the front panel 32 would be translucent and the back panel 34 could be opaque or translucent. The material of the label holder 30 allows the front and back panels 32, 34 to flex relative to one another. As shown in FIG. 1, the label holder 30 can hold a label 38 between the front panel 32 and the back panel 34. Specifically, the label 38 biases the front panel 32 forward and away from the back panel 34 to open and close a cavity 40 formed between the front and back panels 32, 34. This cavity 40 can be used for holding the label 38 therebetween. In an embodiment, the front panel 32 tapers relative to the back panel 34 when no label is positioned therebetween. In a preferred embodiment the taper is approximately between 1 degree and 5 degrees.

The label holder 30 further includes a secondary sign clip 44 for holding a secondary sign 46. The secondary sign 46 may be any label, placard, sign, index card, flyer or other paper-like means for displaying information. The sign clip 44 pinches the secondary sign 46 between the front surface 48 of the front panel 32 and a terminating leg portion 50 of the sign clip 44. As such, the sign clip 44 secures the secondary sign 46 in a location forward of the front panel 32. This position makes attaching and removing the secondary sign 46 quick and easy. Additionally, this position makes the secondary sign 46 stand out from the rest of the display drawing consumer's attention.

With reference to FIGS. 1-3, in the illustrated embodiment, the terminating leg portion 50 of the clip includes a gripping surface that may include a plurality of ribs 52 extending rearwards toward the front panel 32. The ribs focus the impact force to help grip and engage the secondary sign 46. The ribs 52 extend the horizontal length of the label holder 30. The ribs 52 have a varying profile such that the ribs become narrower toward the rib tips 53. It will be appreciated that the leg portion 50 is not limited to having three ribs 52, but may have more or less than three ribs 52 and may even have no ribs at all.

The sign clip 44 is movable between a normal state (see FIG. 2) and extended biased state (see FIG. 1) via a first integral hinge 56. The first integral hinge 56 secures the sign clip 44 to a top portion of the front panel 32 and allows the sign clip 44 to pivot relative to the front panel 32 when a secondary sign 46 is inserted between the leg portion 50 and the front panel 32. In the biased state, the leg portion 50 of the sign clip 44 is spaced apart from the front surface 48. During the normal state, when no sign is present, the leg portion 50 is proximate the front surface 48. In an embodiment, the leg portion 50, particularly the rib tips 53 of the plurality of ribs 52, touch the front surface 48 in the normal state. In an embodiment, in the normal state, the sign clip 44 is urged against the front surface and the resiliency in the sign clip 44 positively spring loads the leg portion 50 against the front surface 48. As is shown, the location where the leg portion 50 presses against the front surface 48 is substantially planar and free of any ribs.

The first integral hinge 56 is connected to the top of the front panel 32 and extends forwardly therefrom to form a generally U-shaped top portion of the clip. In the illustrated embodiment, the sign clip 44 also includes a second integral hinge 60 between the first integral hinge 56 and the terminating leg portion 50. This bottom hinge 60 forms a generally U-shaped lower portion of the clip. The terminating leg portion 50 extends vertically upward from the second integral hinge 60 and terminates in a free end. As such, the second integral hinge 60 forms the bottommost portion of the sign clip 44.

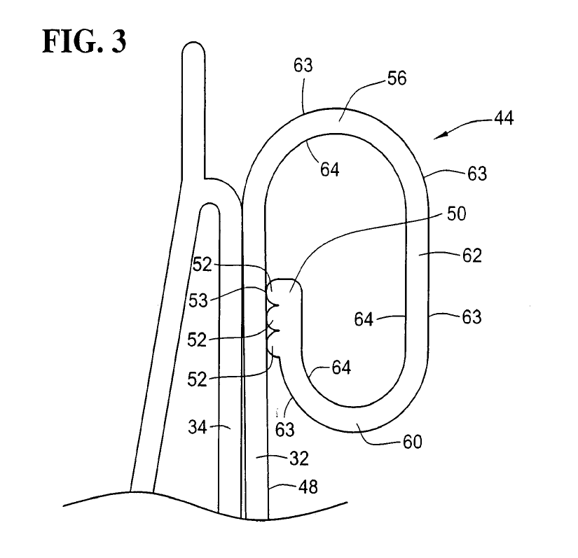

As is shown in FIGS. 2 and 3, the first and second integral hinges 56, 60 give the sign clip 44 a substantially oval cross-section in the normal state. The first and second integral hinges 56, 60 are substantially semi-circular and connected by a straight generally vertical, extension portion 62. The semi-circular outer surface of the second integral hinge provides a guide for inserting and directing signs 46 into the clip 44. The leg portion 50, the second integral hinge 60 and the extension portion 62 form the U-shaped profile. Furthermore, the second integral hinge 60 extends rearward from the extension portion 62 such that the second integral hinge 60 is positioned below and/or curled under the first integral hinge 56. As such, the diameter of the first integral hinge 56 is larger than the second integral hinge 60. However, it will be appreciated that the sign clip 44, through the U-shapes of the first and second integral hinges 56, 60, can approximate other shapes such as an ellipse, a circle, a rectangle, or other loop like shapes, all of which are meant to be encompassed by “generally U-shaped.” In the normal state, the leg portion 50 is preferably substantially parallel to the front panel 32 and the extension portion 62. By “substantially parallel,” it is meant that the leg portion 50 is canted at no more than about 20 degrees relative to the front panel 32 and more preferably no more than about 10 degrees.

As shown in FIG. 3, the curled or looped shape of the sign clip 44 provides that the exterior surface 63 of the sign clip 44 merges into the back surface of the front panel 32. Furthermore, an interior surface 64 of the sign clip 44 merges into the front surface 48 of the front panel 32. The exterior surface 63 and interior surface 64 of the sign clip 44 meet at the terminating vertical end of the leg portion 50.

With reference to FIGS. 1 and 2, the label holder 30 includes a shelf mount 68 for securing the label holder 30 to the shelf structure 10. The shelf mount 68 extends rearward from the back panel 34. In this embodiment, the back panel 34 is interposed between the front panel 32 and the shelf mount 68 and connects the front panel 32 to the shelf mount 68. The shelf mount 68 includes a resiliently flexible mounting strip 72 that extends between first and second distal ends 74, 76. The distal ends 74, 76 of the mounting strip 72 insert into the top and bottom label holder pockets 20, 22, respectively, to secure the label holder 30 to the shelf structure 10. Specifically, while attaching the label holder 30 to the shelf structure 10, either the first distal end 74 or the second distal end 76 is inserted into the corresponding top or bottom label holder channel 20, 22. Then, the mounting strip 72 is resiliently flexed and the other distal end is inserted into the other corresponding label holder channel. In this embodiment, the distance between the distal ends 74, 76 of the mounting strip 72 is proportionately larger than the distance between the two label holder channels 20, 22 of the shelf structure 10 such that when the mounting strip 72 is inserted therein a pressure fit is established, i.e. the mounting strip 72 is in a flexed condition while mounted to the shelf structure 10.

In this embodiment the entire label holder 30 can be extruded by a single screw head into a unitary body of entirely the same material having the same characteristics and properties. In this embodiment, the entire label holder 30 would be preferably made from a translucent material such that labels 38 secured in cavity 40 may be displayed. In an alternative embodiment, the back panel 34 and shelf mount 68 are extruded from a first material and the front panel 32 and the sign clip 44 are extruded from a second material. This embodiment requires the use of two extension screw heads for extruding, one screw head for each material. In this embodiment, the first and second materials are co-extruded and the two bodies are connected at intersection 80. This embodiment is beneficial when it is desired to have the back panel 34 colored while keeping the front panel 32 and sign clip 44 translucent.

During extrusion, the label holder exits the extrusion die with the leg portion 50 spaced away from the front surface 48 of the front panel 32. However, as indicated previously, in an embodiment, the gripping surface of the leg portion 50 is proximate the front panel 32 and in a preferred embodiment the leg portion 50 may touch and be urged against the front surface 48 of the front panel 32 in the normal state. After exiting the extrusion die, the extruded label holder is passed through a calibration die that presses the sign clip 44 toward the front panel 48 to appropriately position the leg portion 50 relative to the front panel 32. Specifically, the clip 44 is urged towards and/or against the front panel 32 closing the gap therebetween.

A further benefit of the sign clip 44 is that the sign clip 44 simplifies replacing the label 38 stored in the cavity 40. The sign clip 44 provides a handle for a user to grasp and pull to more easily spread the front panel 32 from the back panel 34 while removing an old label or adding a new label.

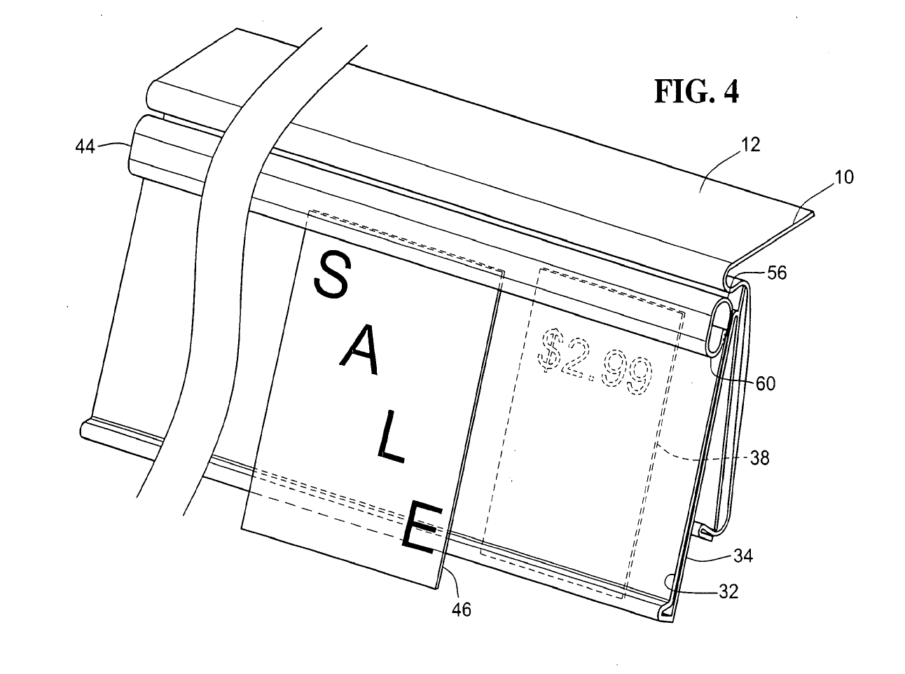

Referring now to FIG. 4, a perspective broken view of the label holder 30 is shown illustrating that the label holder 30 can be of any suitable length appropriate for any length of shelf structure 10. As one skilled in the art will appreciate, the size of the label holder 30 can be adjusted for different sized shelf structures 10. In a typical embodiment, as shown in FIGS. 1 and 4, the label holder 30 does not project above the top panel 12 of the shelf structure 10, thereby enabling customers to easily remove products from the shelf structure 10. With reference to FIGS. 1 and 2, the height of the cavity 40 defined between the front panel 32 and back panel 34 can be adjusted for different sized labels 38. It is a benefit of the featured shelf mount 68 that the cavity 40 is not limited to the height of the front panel 14 of the shelf structure 10. Typically, however, the height of the label holder 30, at least in some embodiments, can be approximately between about 1 1/8″ and about 1 2″ or between approximately 3″ and 6″.

It is preferable that the height of the sign clip 44 is such that the sign clip 44 does not significantly block or obscure sight of a significant portion of the front panel 32 thereby allowing sufficient visibility of labels 38 inserted into the cavity 40. It is preferable that the height of the sign clip 44 from the top integral hinge 56 to the bottom integral hinge 60 be approximately between about 1/8″ and about 3/8″.

Furthermore, as the thickness of the sign clip 44, particularly the thickness of the first and second integral hinges 56 and 60, affects the gripping strength of the sign clip 44, the sign clip 44 can be configured to hold heavier and/or slicker signs 46 by increasing the thickness of the sign clip 44. In a preferred embodiment, the sign clip 44 and the front panel 32 have a substantially uniform thickness, and the thickness being between about 1/100″ to about 3/100″. The distance that the leg portion 50 is biased away from the front surface 48 also affects the amount of gripping force for a given clip thickness. Thus, if the sign clip 44 is only going to be biased a very small distance, i.e. when holding a very thin secondary sign 46, the clip thickness can be increased to increase the gripping force provided by the smaller biased distance from the front surface 48.

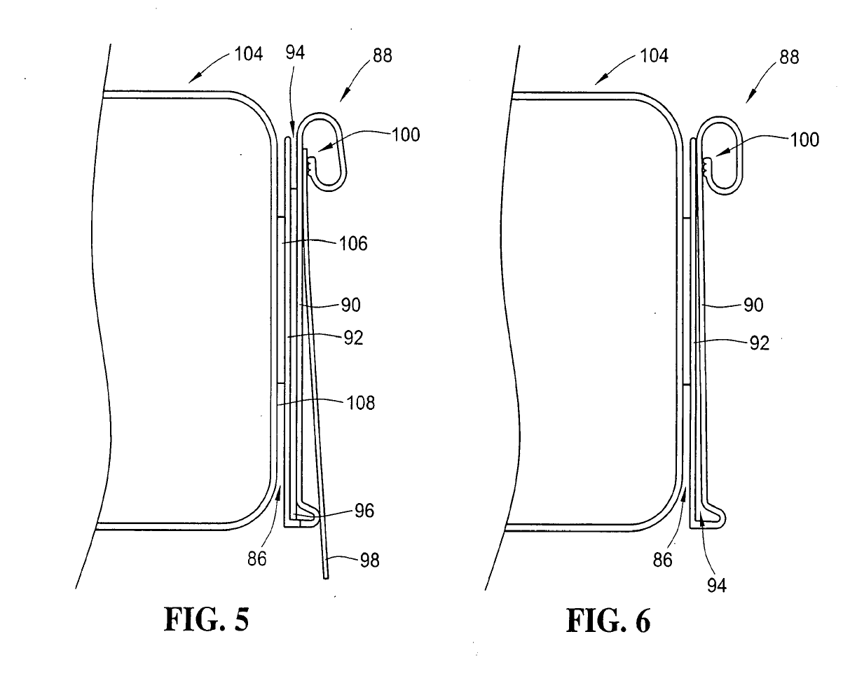

An alternative embodiment of a label holder 86 is illustrated in FIGS. 5 and 6. This embodiment is similar to the previous embodiment in that it includes a sign clip 88, front and back panels 90, 92 that form a cavity 94 therebetween for holding a label 96. The sign clip 88 secures a secondary sign 98 between a leg portion 100 of the sign clip 88 and the front panel 90 as explained previously.

The label holder 86 includes different shelf mount structure and is mounted to the shelf structure 104 by adhesive means 106. The adhesive means 106 can be any adhesive means that are sufficiently strong to secure the label holder 86 to the front face 108 of the shelf structure 104. This could be in the form of a liquid adhesive that is spread onto the front face 108 of the shelf structure 104 that secures the label holder 86 to the shelf structure when it sets and/or cures. Alternatively, the adhesive means could be in the form of double sided roll-type adhesive such as what is referred to as double-sided tape.

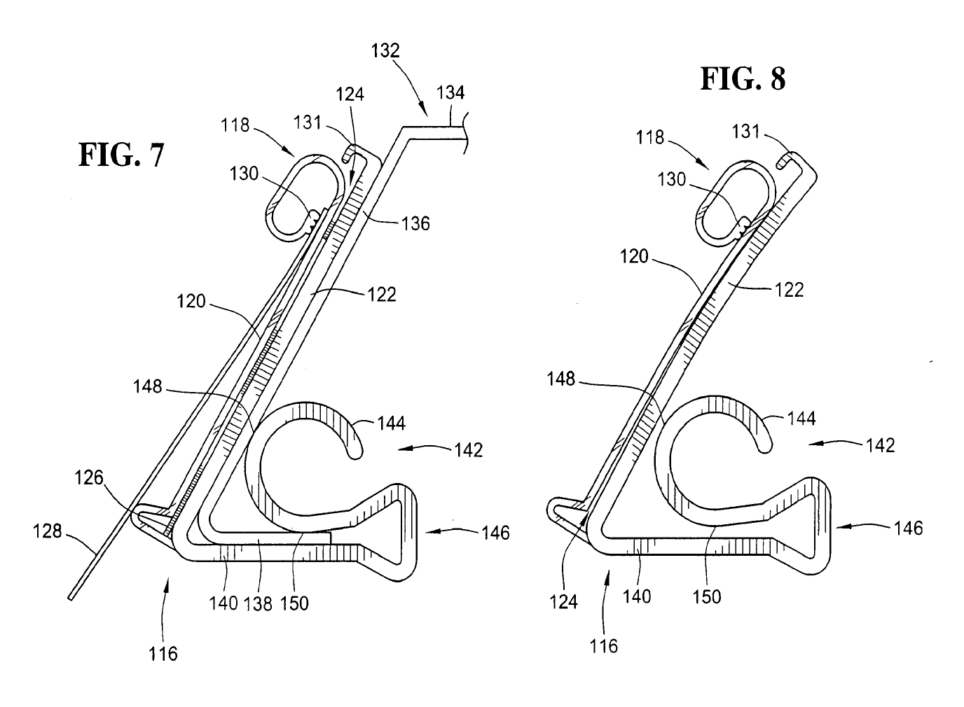

An alternative embodiment of a label holder 116 according to the teachings of the present invention is illustrated in FIGS. 7 and 8. The embodiment is similar to the previous embodiments in that it includes a sign clip 118, a front panel 120 and a back panel 122 that form a cavity 124 therebetween suitable for receiving a label 126. The sign clip 118 secures a secondary sign 128 between a leg portion 130 of the sign clip 118 and the front panel 120 as explained previously.

The label holder 116 further includes a protective flange 131 that is integral with and extends forwardly from the back panel 122 over the front panel 120 and a portion of the sign clip 118. The protective flange 131 helps prevent labels 126 from being erroneously removed from the cavity 124. The sign clip 118 greatly assists a user in inserting and removing the label 126 from the cavity 124 by making it easier to grip and to separate the front panel 120 from the back panel 122. The protective flange 131 could take other shapes or forms such as being just a forward projecting rib.

One type of shelf structure 132 that the label holder 116 may be mounted to includes a top surface 134, a flat angled front panel 136 and a lower support flange 138 and is illustrated in FIG. 6. The shelf structure 132 and similar shelf structures are of the type typically referred to as Darling or Syndicate type flat-faced shelving.

The label holder 116 further includes a flat bottom surface 140 extending rearwardly from the back panel 122. The flat bottom surface 140 is part of a shelf mount 142. The shelf mount 142 also includes a forwardly-facing, spring clip 144 connected to a rearward end 146 with an opening at an end of spring clip 144 that provides resilient clamping onto the shelf structure 132 by two clamp points identified by reference numbers 148 and 150. The area between the back panel 122, bottom surface 140 and spring clip 144 forms a gripping channel including the clamp points 148 and 150, as is best illustrated in FIG. 8.

The embodiment requires the front and back panels 120, 122 to flex from a relaxed state (FIG. 8) to a biased state (FIG. 7) when mounted to the shelf structure 132. In the relaxed state, the front and back panels 120, 122 have a resilient curve. As illustrated in FIG. 7, after mounting to shelf structure 132 the front and back panels 120, 122 are biased such that they are substantially straight and substantially parallel to front panel 136 of the shelf structure 132.

Referring to FIG. 7, to mount the label holder 116 onto shelf structure 132, the spring clip 144 and the back panel 122 resiliently flex around the shelf structure 132 at the lower support flange 138. The shelf mount 142, with the spring clip 144, and the rearward end 146, function as a spring to provide resilient attachment to the shelf structure 132. After attaching the label holder 116 to the shelf structure 132, the label holder 132 grips the angled front panel 136 and lower support flange 138 by having the spring clip 144 grip both the angled front panel 136 and the lower support flange 138 at the same time. When in the fully mounted position, the back panel 122 lies substantially flush with the angled front panel 136; and the flat bottom surface 140 lies substantially flush with the lower support flange 138. During mounting, the shelf mount 142, including the spring clip 144, the bottom surface 140 and the rearward end 146 resiliently extend around the lower support flange 138 of the shelf structure 132 and the flexure of the shelf mount 142 and the front and back panels 120, 122 improve the securement of the label holder 116 to the shelf structure 132.

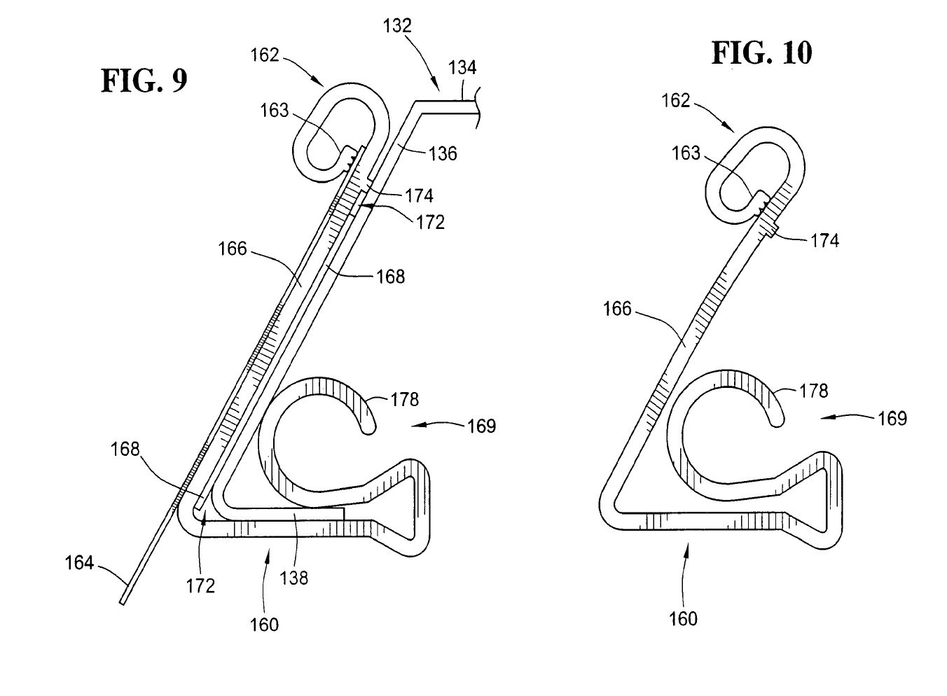

A further alternative embodiment of a label holder 160 in accordance with the teachings of the present invention is illustrated in FIGS. 9 and 10. The label holder 160 is similar to the previous embodiments in that it includes a sign clip 162 having a leg portion 163 for holding a secondary sign 164 between the leg portion 163 and a front panel 166 of the label holder 160. Additionally, the front panel 166 protects a label 168 positioned behind the front panel 166, as illustrated in FIG. 9.

The label holder 160 includes a similar shelf mount 169 and similarly mounts to the same shelf structure 132 as the embodiment illustrated in FIGS. 7 and 8. However, as is shown in FIG. 9, the label holder 160 has only one panel, i.e. front panel 166. The front panel 166 and front panel 136 of the shelf structure 132 create, therebetween, the cavity 172 for holding the label 168. In an embodiment, the label holder 160 optionally includes a rib 174 extending rearward from the front panel 166 and positioned proximate the sign clip 162. The rib 174 extends along an entire lateral span of the label holder 160 and is generally parallel with sign clip 162.

The rib 174 performs several beneficial functions. First, the rib 174 engages the front panel 136 of the shelf structure 132 prior to the rest of the front panel 166. In fact, as shown in FIG. 9, the rib 174 is the only portion of the front panel 166 that contacts the front panel 136. The rib 174 assists in biasing the front panel 166 from a relaxed state (FIG. 10) to a biased state (FIG. 9).

As the transition from the relaxed state to the biased state occurs, the flexure of the front panel 166 from a curved panel (FIG. 10) to generally planar, straight, and/or flat panel (FIG. 9) promotes and/or causes spring clip 178 of the shelf mount 169 to engage with the front panel 136 as shown in FIG. 9. Therefore, in this embodiment, the rib 174 and shelf mount 169 ensure that the spring clip 178 positively and forcibly engages the front panel 136 when the label holder 160 is clamped to a shelf structure 132.

When the label 168 is disposed within the cavity 172, the rib 174 acts as a “lid” and/or “stop” to inhibit and/or prevent the label from being unintentionally removed from the cavity 172. Even so, because the front panel 166 is flexible, if the label 168 needs to be removed, the front panel 166 can simply be biased away from the front panel 136 until the rib 174 and the front panel 136 disengage and form an opening of the cavity 172. The label 168 can then be easily slid and/or pulled upwardly and out of the cavity 172 for removal, replacement, cleaning, repositioning, and the like. Furthermore, the sign clip 162 for holding the sign 164 may function as a handle and allow the user to more easily separate the front panel 166 of the label holder 160 from the shelf structure 132.

As the previous paragraphs demonstrate, the present invention performs several beneficial functions. The sign clip provides an additional means for holding label or signs for providing additional or temporary information about displayed product. The sign clip may act as a handle for biasing the front panel of the label holder in a forward direction such that removal of labels displayed behind and protected by the front panel of the label holder is made easier. A further aspect of the present invention is that the components of the label holder may be extruded from like material reducing the number of extrusion screw heads required during manufacture.

All references, including publications, patent applications, and patents cited herein, are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A label holder for a retail display apparatus including a shelf, the label holder comprising:
a front panel of a plastic material having a front surface;
a clip of a plastic material integrally connected to the front panel via a first integral hinge and pivoting relative to the front panel through the first integral hinge, the clip having a second integral hinge disposed between the first integral hinge and a leg portion extending upwardly from the second integral hinge toward the first integral hinge, the leg portion having a gripping surface, the gripping surface and front surface facing one another, the gripping surface including at least one rib projecting towards the front surface for increasing localized engagement of a sign positioned between the gripping surface and the front panel, wherein the clip and front panel consist of a single material of a constant hardness characteristic; and
a shelf mount structure connected to front panel adapted to mount the front panel on the shelf
the front panel and clip being extruded from the same plastic material and a single screw head, the front panel and clip extending longitudinally between a first end and a second end defining a same cross-sectional shape at all locations between the first end and second end.

2. The label holder of claim 1, wherein the leg portion projects along a direction that is substantially parallel to the front panel.

3. The label holder of claim 1, wherein the front panel has a planar surface free of ribs or interruptions forming a contact zone for the leg portion of the clip.

4. The label holder of claim 1, wherein the leg portion terminates in an terminating end, wherein the clip defines an interior surface starting at said front panel and extending along a hollow interior of the clip through the first and second hinges to said terminating end, and wherein the clip defines an exterior surface starting at said front panel and extending exteriorly around the first and second hinges to said terminating end, the exterior surface of the leg portion providing said gripping surface.

5. The label holder of claim 4, wherein at least one rib projects from the exterior surface toward the front panel to form said gripping surface.

6. The label holder of claim 5, wherein the at least one rib includes a plurality of ribs projecting from the exterior surface to form said gripping surface, each rib projecting toward the front panel, each rib extending entirely between the first and second ends.

7. The label holder of claim 1, wherein the gripping surface is in contact with and positively spring loaded through resiliency of the hinges against the front panel.

8. The label holder of claim 1, wherein the clip pivots through at least one of the first and second integral hinges between a normal state wherein the leg portion is proximate the front surface and a biased state wherein the leg portion is spaced apart from the front surface when a sign is inserted therebetween, in the biased state at least one of the first and second integral hinges resiliently biases the leg portion towards the front surface of the front panel.

9. The label holder of claim 1, wherein the first and second integral hinges are substantially semi-circular and the first integral hinge has a first radius larger than a second radius of the second integral hinge.

10. The label holder of claim 9, wherein the second integral hinge is integrally connected to the first integral hinge by a generally straight extension portion, the generally straight extension portion being substantially parallel to the front panel, and wherein the second integral hinge is below the first integral hinge.

11. The label holder of claim 1, further including a back panel, the back panel integrally connected to the front panel along a common bottom hinge, said front panel pivoting relative to the back panel about said bottom hinge, the combination of the front and back panels forming a pocket therebetween for receiving a label, and the back panel interposed between the shelf mount structure and the front panel.

12. The label holder of claim 1, wherein the clip has a height of between about 1/8 inches to 3/8 inches and the front panel has a height of a between about 1 inches to about 3 inches, and wherein the clip has a width of between about 1/8 inches and about 1/4 inches, and wherein the first hinge has a width of between about 1/8 inches and about 1/4 inches, and the second hinge has a width of between about 1/8 inches and about 3/16 inches.

13. The label holder of claim 12, wherein the front panel and the clip including the first integral hinge and the second integral hinge have a thickness between about 1/100 inches to about 3/100 inches.

14. A label holder for a retail display apparatus including a shelf, the label holder comprising:
a front panel formed of a plastic material;
a clip integrally connected along a top portion of the front panel, the clip including a top portion extending forward of the front panel and a generally U-shaped bottom portion, the generally U-shaped bottom portion having an outer leg portion and an inner leg portion joined at a bottommost boundary of the clip, the inner leg portion extending upwardly and spaced between the outer leg portion and the front panel, the at least one rib providing for increased localized engagement of a sign that is positioned between the gripping surface and the front panel;
a sign entrance gap formed between the U-shaped bottom portion and the front panel;
a shelf mount structure connected to the front panel adapted to secure the label holder to the shelf; and
the front panel and clip being extruded from the same plastic material and a single screw head, the front panel and clip extending longitudinally between a first end and a second end defining a same cross-sectional shape at all locations between the first end and second end.

15. The label holder of claim 14, further including a back panel joined to the front panel at a bottom hinge, the back panel interposed between the front panel and the shelf mount structure the front and back panels forming a label receiving pocket therebetween.

16. The label holder of claim 15, wherein the clip defines an interior surface starting at said front panel and extending to an upper terminating end of the inner leg portion, and wherein the clip defines an exterior surface starting at said front panel and extending to said terminating end, the bottommost boundary being part of the exterior surface.

17. The label holder of claim 15, wherein the leg portion includes a gripping surface facing the front surface of the front panel, and wherein the gripping surface is in contact with and positively spring loaded through resiliency of at least one of the top portion and U-shaped portion, against the front panel.

18. The label holder of claim 17, wherein the gripping surface includes at least one rib.

19. The label holder of claim 15, wherein the front panel and the clip are integrally formed from a single material throughout having the same common hardness characteristic.

20. The label holder of claim 17, wherein the top portion and the generally U-shaped bottom portions are both semi-circular in shape, and wherein the top and bottom portions act as upper and lower integral hinges.

21. A method of forming a label holder for a retail display apparatus including a shelf, the method comprising:
extruding a front panel and a clip through an extrusion die using a single screw head and the same plastic material such that the front panel and clip are a continuous piece of material;
wherein the front panel has a front surface,
wherein the clip is integrally connected to the front panel via a first integral hinge and pivoting relative to the front panel through the first integral hinge, the clip has a second integral hinge disposed between the first integral hinge and a leg portion extends upwardly from the second integral hinge toward the first integral hinge, the leg portion has a gripping surface, the gripping surface and front surface face one another, the gripping surface includes at least one rib projecting towards the front surface for increasing localized engagement of a sign positioned between the gripping surface and the front panel;
wherein the clip and front panel consist of a single plastic;
wherein the front panel and clip extend longitudinally between a first end and a second end defining a same cross-sectional shape at all locations between the first end and second end; and
extruding a shelf mount structure, the shelf mount structure being connected to front panel and adapted to mount the front panel on the shelf.

22. A method of forming a label holder for a retail display apparatus including a shelf, the method comprising:
extruding a front panel and a clip through an extrusion die using a single screw head and the same plastic material such that the front panel and clip are a continuous piece of material;
wherein the clip is integrally connected along a top portion of the front panel, the clip includes a top portion extending forward of the front panel and a generally U-shaped bottom portion, the generally U-shaped bottom portion having an outer leg portion and an inner leg portion joined at a bottommost boundary of the clip, the inner leg portion extends upwardly and spaced between the outer leg portion and the front panel, the at least one rib provides for increased localized engagement of a sign that is positioned between the gripping surface and the front panel;
wherein a sign entrance gap is formed between the U-shaped bottom portion and the front panel;
wherein the front panel and clip extend longitudinally between a first end and a second end and define a same cross-sectional shape at all locations between the first end and second end; and
extruding a shelf mount structure connected to the front panel adapted to secure the label holder to the shelf.
